(19) United States
(12) Patent Application Publication
(10) Pub. No.: US 2025/0242326 A1
(43) Pub. Date: Jul. 31, 2025

(54) Carbon Black Reactor Having Cooling Function

(71) Applicant: ORION KOREA CO., LTD., Yeosu-si (KR)

(72) Inventors: Byoung Wan Park, Yeosu-si (KR); Hyung Ju Kim, Yeosu-si (KR)

(21) Appl. No.: 18/866,867

(22) PCT Filed: May 18, 2023
(86) PCT No.: PCT/KR2023/006753

§ 371 Date: Nov. 18, 2024

(30) Foreign Application Priority Data
May 19, 2022 (KR) 10-2022-0061414

(51) Int. Cl. B01J 19/26; B01J 4/00; B01J 10/00; B01J 19/00; B01J 19/02; C09C 1/50

(52) U.S. Cl. CPC B01J 19/26; B01J 4/002; B01J 10/00; B01J 19/0013; B01J 19/02; C09C 1/50; B01J 2204/002; B01J 2204/007; B01J 2219/00081; B01J 2219/00085; B01J 2219/0286

(57) ABSTRACT

A carbon black reactor has a cooling function that does not change the diameter of the combustion port by continuously cooling the combustion port of the reactor. The carbon black reactor includes a body made of a metallic material which has a pair of flanges spaced apart from each other, and a combustion port with a central portion penetrated which combustion gas and feedstock oil are reacted while connecting the spaced flanges. A plurality of injection nozzles are configured to inject a feedstock oil into the combustion port, and a pair of cooling rooms are respectively provided on an inner plate surface of the flange facing each other A distribution cooling pipe surrounds an outer circumferential surface of the combustion port to be spaced apart to form a flow path, and is partitioned into a first supply flow path and a second supply flow path through a partition panel.

### CROSS-REFERENCE TO RELATED APPLICATIONS

This application is the United States national phase of International Patent Application No. PCT/KR2023/006753 filed May 18, 2023, and claims priority to Korean Patent Application No. 10-2022-0061414 filed May 19, 2022, the disclosures of which are hereby incorporated by reference in their entireties.

### BACKGROUND OF THE INVENTION

### Field of the Invention

The present disclosure relates to a carbon black reactor, and more particularly, to a carbon black reactor having cooling function without change of a diameter of a combustion port disposed inside the reactor by continuously cooling the reactor that causes a chemical reaction at a high temperature to produce carbon black.

### Description of Related Art

In general, carbon black is widely used in various fields such as inks, paints, reinforcing fillers, conductive materials, positive electrode materials of secondary batteries, electromagnetic shielding materials, and heating members. The carbon black has excellent physicochemical and thermal properties including conductivity, chemical resistance, weather resistance, and heat resistance, and is produced in the form of pellets, powders, and the like together with various ceramic materials and is applied to various kinds of product additives.

Thus, making uniformly dispersed carbon black products is an important factor in casting processes such as slip-casting, tape-casting, injection molding and extrusion.

The carbon black is produced by a Furnace method, a Channel method, a Thermal method, an Acetylene method, or the like, among which the furnace method is the most commonly used because it may produce carbon black more efficiently.

In the Furnace process, as shown in FIG. 1, a liquid or gaseous combustion oil is supplied together with air to the inside of a heating furnace 10 in which the inside is heated to a high temperature through a nozzle to react with an oxidizing agent to generate a high-temperature combustion gas, and the generated combustion gas is chemically reacted with the feedstock oil at a high temperature (1500 degrees or more) while passing through a reactor 20 in which the feedstock oil (bunker C oil or the like) is injected to the inside through an injection nozzle 21, causing incomplete combustion, pyrolysis, or dehydrogenation reaction to generate a mixed gas including carbon black, and the generated mixed gas is manufactured and commercialized into a product in a specified shape, such as a pellet or bead, through a post-process, the conventional capture process and molding process.

In this case, since the reactor 20 is in a high-temperature environment due to combustion of combustion gas and feedstock oil and the movement speed increases, so the interior must be applied with a refractory material 23 that has high heat resistance.

As shown in FIG. 2, such refractory material 23 is disposed inside the reactor while maintaining a predetermined thickness, and a circular combustion hole 25 in which the feedstock oil and the combustion gas supplied to the central portion are combusted is formed.

However, even if the refractory material 23 has high heat resistance, since the combustion port 25 continuously maintains a high-temperature environment, the internal diameter of the combustion port 25 of the refractory material 23 gradually melts and changes in the shape of the internal diameter occur during use for about 3 to 4 months, so that the reactor 20 must be replaced periodically.

If continuous operation is performed with the internal diameter of the combustion port 25 changed, there is a fatal problem of occurrence of a change in the production amount according to the set data value of the combustion port and poor quality of carbon black.

Furthermore, since the refractory material is made of class 1 carcinogens, there is also an environmental problem of disposal.

### PRIOR ART DOCUMENTS

### Patent Document

(Patent Document 1) Korean Publication Patent No. 10-2019-0078848

(Patent Document 2) Korean Registered Patent No. 10-0602542

### SUMMARY OF THE INVENTION

### Technical Problem

The present disclosure has been devised to solve the above problems and technical prejudices, and an object of the present disclosure is to provide a carbon black reactor having cooling function that prevents change of the diameter of the combustion port by cooling the entire combustion port by continuously circulating cooling water through the combustion port, which is made of metallic material and is heated to a high temperature.

### Problem Solving Means

A carbon black reactor having cooling function of the present disclosure for achieving the above object includes: a body made of a metallic material which has a pair of flanges spaced apart from each other, and a combustion port 113 with a central portion penetrated which combustion gas and feedstock oil are reacted while connecting the spaced flanges; a plurality of injection nozzles configured to inject a feedstock oil into the combustion port; a pair of cooling rooms respectively provided on an inner plate surface of the flange facing each other, and configured to exchange heat of the flanges while diffusing cooling water across the entire surface of the flanges; a distribution cooling pipe that surrounds an outer circumferential surface of the combustion port to be spaced apart to form a flow path, and is partitioned into a first supply flow path and a second supply flow path through a partition panel so that the supplied cooling water is directed to each cooling room while exchanging heat with the entire combustion port; a pair of cooling water supply pipes provided in the first supply flow path and the second supply flow path, respectively, and configured to supply cooling water; and a cooling water drain pipe, which is provided in each of the pair of cooling rooms and drains heat-exchanged cooling water.

In this case, the cooling room is preferably composed of a circular cooling housing disposed on an inner plate surface of the flange while penetrating the distribution cooling pipe, and forming a cooling space so that cooling water can induce from the distribution cooling pipes for heat exchange of the flanges; and a spiral guide disposed inside the cooling housing and forming a flow path so that cooling water inducing from the distribution cooling pipe is spirally diffused toward the outside of the flange plate surface.

In addition, it is preferable that an inlet hole communicating with the cooling room is formed at both ends of the distribution cooling pipe so that cooling water supplied to the first and second supply flow paths, respectively, flows into the cooling room.

Further, it is preferable that a gap is formed inside each of the first and second supply flow paths of the distribution cooling pipe so as to be spaced apart from an outer circumferential surface of the combustion port in an inclined manner in a range of 25 degrees to 35 degrees in a state of being fixed to the distribution cooling pipe, so that a flow velocity of cooling water passing through the gap can be concentrated to both end portions of the combustion port.

And, it is preferable that a recessed section for delaying a flow time of cooling water is formed on a flange plate surface provided with the cooling room so that heat exchange of the cooling water flowing in the cooling room can be concentrated around end portions of the combustion port.

On the other hand, it is preferable that the injection nozzle is coupled to a plurality of injection sockets penetrating the distribution cooling pipe in a state of being radially disposed in the combustion port.

In addition, it is preferable that a notch portion made of a heat-resistant metal material for reinforcing the carbonization of the diameter corner of the combustion port is further provided around the diameter of the end portion on one side of the combustion port.

Finally, it is preferable that a plurality of supporter members disposed radially between the pair of flanges to maintain a spaced-apart state of the flanges.

### Effects of the Invention

According to the carbon black reactor having cooling function of the present disclosure having the above configuration, the carbon black reactor of the present disclosure has an excellent effect of fundamentally preventing the diameter of the combustion port from being deformed by continuous exposure at a high temperature as in the related art by manufacturing the combustion port of carbon black reactor with a heat-resistant metallic material, supplying cooling water in both directions to increase the cooling efficiency of the combustion port heated to a high temperature, and cooling the combustion port while the supplied cooling water flows in a state where it is enveloped by cooling water.

In particular, the structural effect of further enhancing the stability of the vulnerable portion by allowing the flowing cooling water to concentrate to the vulnerable portion around the diameter of the end portion of the combustor is also excellent.

Further, it is possible to keep the quality of a carbon black produced constant as the shape of the combustion port of the carbon black reactor is maintained, and above all has the effect of not generating refractory waste as in the prior art.

### BRIEF DESCRIPTION OF THE DRAWINGS

FIG. 1 is a reference view in which a conventional reactor is installed in a carbon black production system,

FIG. 2 is a perspective view of a conventional reactor,

FIG. 3 is a reference diagram in which a carbon black reactor of the present disclosure is installed in a carbon black production system,

FIGS. 4 and 5 are a perspective view and a detailed cross-sectional view illustrating the carbon black reactor of the present disclosure,

FIG. 6 is a detailed cross-sectional view taken along line I-I of FIG. 5, in which the cooling housing of the cooling room is removed, and

FIG. 7 is a detailed cross-sectional view taken along line II-II of FIG. 5, in which the cooling housing of the cooling room is removed.

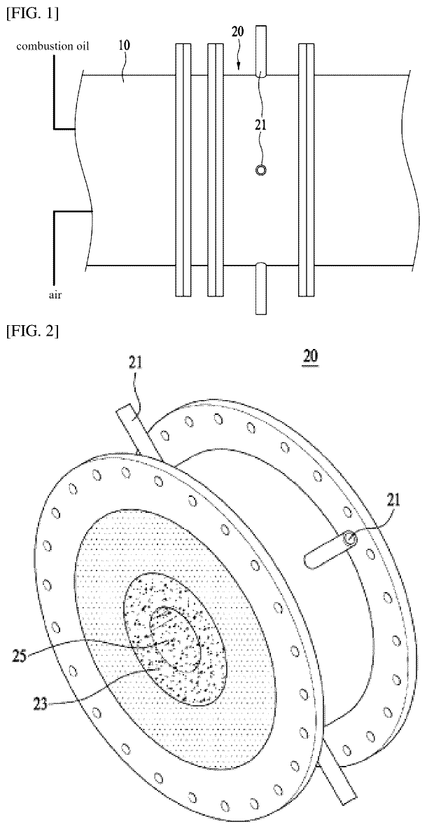

### DESCRIPTION OF THE INVENTION

Hereinafter, preferred embodiments of the present disclosure will be described in more detail with reference to the accompanying figures. The embodiments of the present disclosure may be modified into various forms, and the scope of the present disclosure should not be construed as limited to the embodiments described below. The present embodiments are provided to explain the present disclosure in more detail to those skilled in the art. Accordingly, the shape of each element shown in the figures may be exaggerated to emphasize a more explicit description.

The terms first, second, etc. may be used to describe various components, but the components should not be limited by the terms. The terms are only used for the purpose of distinguishing one component from another.

The terminology used herein is for the purpose of describing particular embodiments only and is not intended to be limiting of the disclosure. The singular forms “a,” “an,” and “the” include plural referents unless the context clearly dictates otherwise. In this application, it should be understood that the terms “comprise” or “have” and the like are intended to specify that there are features, numbers, steps, operations, components, parts, or combinations thereof described in the specification, but do not preclude in advance the presence or addition possibility of one or more other features or numbers, steps, operation, components, parts or combinations thereof.

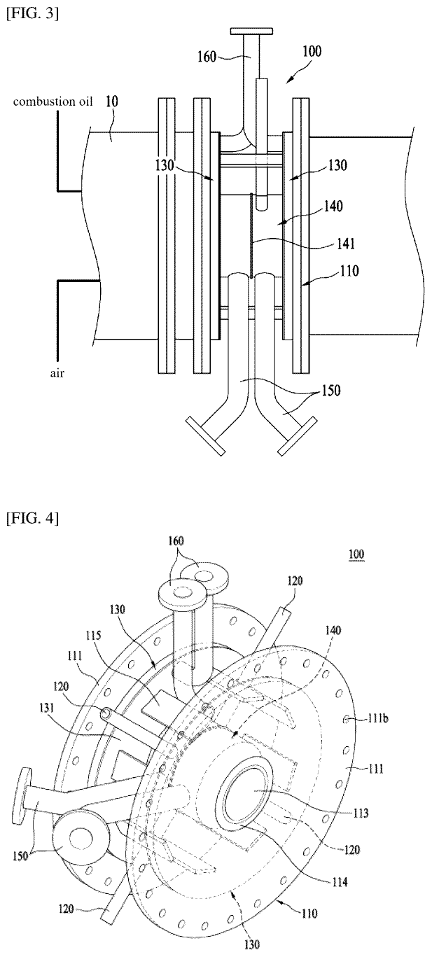

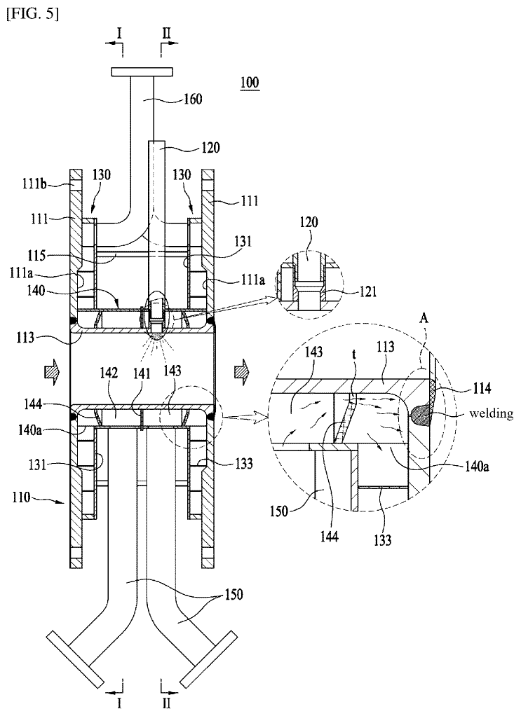

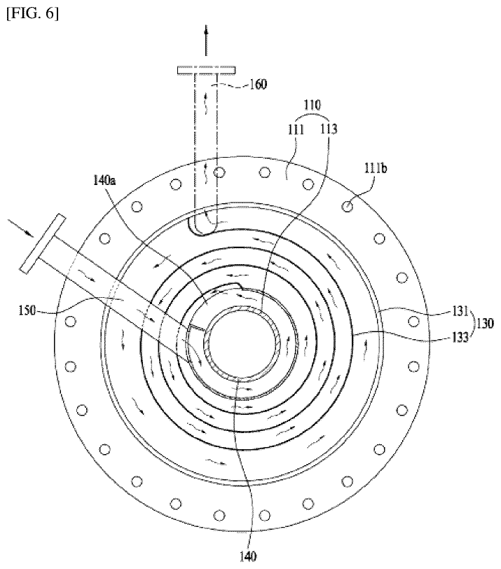

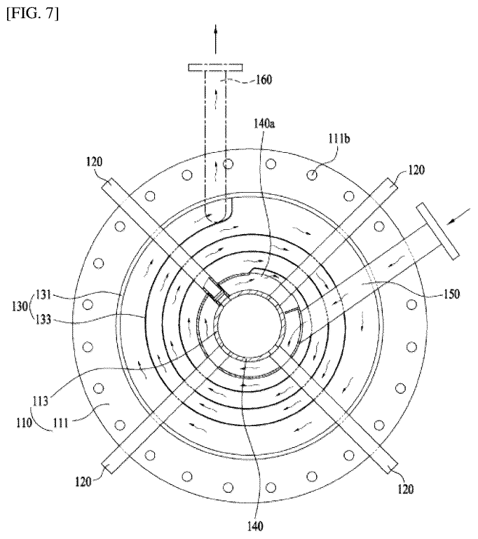

FIG. 3 is a reference diagram in which a carbon black reactor of the present disclosure is installed in a carbon black production system, FIGS. 4 and 5 are a perspective view and a detailed cross-sectional view illustrating the carbon black reactor of the present disclosure, FIG. 6 is a detailed cross-sectional view taken along line I-I of FIG. 5, in which the cooling housing of the cooling room is removed, and FIG. 7 is a detailed cross-sectional view taken along line II-II of FIG. 5, in which the cooling housing of the cooling room is removed.

As shown in FIG. 3 to FIG. 7, the carbon black reactor 100 of the present disclosure includes: a body 110 made of a metallic material which has a pair of flanges 111 spaced apart from each other, and a combustion port 113 with a central portion penetrated which combustion gas and feedstock oil are reacted while connecting the spaced flanges 111; a plurality of injection nozzles 120 configured to inject a feedstock oil into the combustion port 113; a pair of cooling rooms 130 respectively provided on an inner plate surface of the flange 111 facing each other, and configured to exchange heat of the flanges 111 while diffusing cooling water across the entire surface of the flanges 111; a distribution cooling pipe 140 that surrounds an outer circumferential surface of the combustion port 113 to be spaced apart to form a flow path, and is partitioned into a first supply flow path 142 and a second supply flow path 143 through a partition panel 141 so that the supplied cooling water is directed to each cooling room 130 while exchanging heat with the entire combustion port 113; a pair of cooling water supply pipes 150 provided in the first supply flow path 142 and the second supply flow path 143, respectively, and configured to supply cooling water; and a cooling water drain pipe 160, which is provided in each of the pair of cooling rooms 130 and drains heat-exchanged cooling water.

Prior to the description, the most significant feature of the carbon black reactor 100 of the present disclosure is that the combustion port 113 of the reactor for producing a mixed gas containing carbon black through the reaction between the combustion gas and the feedstock oil is made of a metallic material, and the reactor is provided with a structure for cooling the combustion port 113 continuously exposed to a high-temperature environment, so that the diameter shape of the combustion port 113 is not deformed.

In addition, the structure to be described below for forming the carbon black reactor 100 is composed of a heat-resistant metallic material, and each structure is disposed through welding.

Also, a pair with the same structure is given the same sign, and to avoid confusion in the explanation, only a single structure will be described.

The carbon black reactor 100 of the present disclosure is coupled to the heating furnace 10 in the left side of the figure, which produces a high-temperature combustion gas by supplying liquid or gaseous combustion oil together with air to react with an oxidizing agent on a system pipeline for producing carbon black as shown in FIG. 3.

On the right side in the figure of the carbon black reactor 100, a separate transfer pipe is provided so that the mixed gas containing the carbon black generated by the reaction between the combustion gas and the feedstock oil can move to a post-process in the carbon black reactor 10, and since the post-process of the mixed gas is a common matter, its description will be omitted.

This body 110 causes the combustion gas introduced from the heating furnace 10 to react with the feedstock oil supplied, and includes a pair of a flange 111 made of a metallic material and a combustion port 113.

As shown in FIGS. 4 and 5, a pair of flanges 111 have a shape of a disk having a predetermined thickness and are spaced apart from each other by a predetermined interval in a direction facing each other.

The combustion port 113 connects the spaced-apart flanges 111 in a cylindrical shape to each other to form a pair of flanges 111 in an integrated shape, and the central portion of the combustion port 113 penetrates circularly in the longitudinal direction so that the combustion gas inducing from the heating furnace 10 and the feedstock oil supplied through the injection nozzle 120 described below may react with each other.

Here, a pair of flanges 111 and the combustion port 113 are made of different heat-resistant metallic materials, and in the case of the combustion port 113, SUS316L in which the carbon concentration is reduced so as to withstand an environment at a high temperature (not less than 1500 degrees) is preferable, and in the cases of a pair of flange 111, SUS304 in which chromium, nickel, and manganese are added to iron is preferable.

Then, a pair of flanges 111 and the combustion port 113 form a single body 110 shape through welding as shown in FIG. 5.

Further, a plurality of coupling holes 111b which penetrate bolts (not shown) for coupling of flanges 111 with adjacent pipes are formed on the outer circumference portion of the flange 111.

The material of the combustion port 113 and the flange 111 in this embodiment is only an example, and the material is not limited as long as it is a metal that can withstand a high-temperature environment.

On the other hand, as shown in FIG. 5, a notch portion 114 made of a heat-resistant metallic material for reinforcing carbonization of a diameter edge of the combustion port 113 due to a high temperature caused by a reaction between the combustion gas and the feedstock oil, may be further provided on diameter circumference of one end of the combustion port 113 (mixed gas exhaust direction—right side in the figure).

In this case, the notch portion 114 is preferably made of a duplex steel 2207, a heat-resistant metallic material, and is fixed to the diameter edge of the combustion port 113 by welding.

The injection nozzle 120 enables the feedstock oil (bunker C oil) to be directly injected into the combustion port 113 so that the combustion gas flowing into the combustion port 113 may react with the feedstock oil, four nozzles being radially installed along the diameter of the combustion port 113 as shown in FIG. 4 to FIG. 7.

In this case, the injection nozzles 120 are respectively coupled to four injection sockets 121 radially coupled to the combustion port 113 along the diameter of the combustion port 113 in a state of penetrating a distribution cooling pipe 140 described below, and are connected to supply lines of a feedstock oil supply tank (not shown).

Wherein the injection socket 121 is provided to penetrate the distribution cooling pipe 140 is so that a stable support of the injection nozzle 120 coupled to the injection socket 121 may be achieved simultaneously with the support of the injection sockets 121 coupled to the combustion port 113.

In addition, the injection nozzles 120 are connected to a feedstock oil supply tank (not shown), and inject the feedstock oil into the combustion port 113 through the supply pressure.

In the present embodiment, four injection nozzles 120 are provided, but the number is not limited because the number may vary depending on the diameter of combustion port 113.

The cooling room 130 is configured to diffuse the cooling water introduced through the distribution cooling pipe 140 described below to the entire surface of the flange 111 to enable heat exchange (cooling) of the flange 111, and configured as a pair and is provided facing each other on the inner plate surface of a pair of flanges 111.

In detail, the cooling room 130 is configured to allow secondary cooling of the entire surface of the flange 111 in the process of cooling water, which is supplied to the distribution cooling pipe 140 and primarily cools the combustion port 113, flowing toward the cooling water drain pipe 160 described below.

Here, since a pair of cooling rooms 130 have the identical structure as in FIG. 4 to FIG. 7, only a single cooling room 130 will be described, and it includes the cooling housing 131 and the spiral guide 133.

The cooling housing 131 is disposed in a circular shape corresponding to the flange 111 on the inner plate surface of the facing flanges 111 while penetrating the distribution cooling pipe 140 described below, as shown in FIG. 5.

In this case, the cooling housing 131 maintains a predetermined height so that cooling water may induce from the distribution cooling pipe 140 for heat exchange over the entire surface of the flange 111 and a cooling space can be formed in which a spiral guide 133 described below may be disposed.

The spiral guide 133 maintains a spiral shape having a predetermined height as shown in FIG. 6 and FIG. 7, thereby forming a flow path through which the cooling water flowing into the cooling housing 131 may flow.

In detail, the spiral guide 133 is disposed inside the cooling housing 131, and forms a spiral path so that the cooling water that has undergone heat exchange in the combustion port 113 and is induced in through the distribution cooling pipe 140 may diffuse in a spiral shape from the center of the flange 111 toward the outside of the plate surface, thereby allowing heat exchange over the entire surface of the flange 111.

Therefore, the spiral guide 133 forms a long path through which the cooling water flows, thereby expanding the heat exchange contact area and allowing the cooling water to flow quickly through the spiral path.

If there is no spiral guide 133, the cooling water around the cooling water drain pipe 160 described below may be quickly discharged, but the cooling water discharge at a portion distant from the cooling water drain pipe 160 is slowed down, so the temperature distribution of the cooling water flowing inside the cooling room 130 varies, and heat exchange does not occur uniformly.

Meanwhile, as shown in FIG. 5, on the flange 111 plate surface covered by the cooling housing 131 of the cooling room 130, a circular recessed section 111a may be formed with a predetermined height and width centered on the combustion port 113 so that heat exchange of the cooling water flowing along the spiral guide 133 of the cooling room 130 may be concentrated around the end of the combustion port 113.

Such recessed section 111a expands the flow path through which the cooling water can flow deeper and wider, thereby delaying the flow time of the cooling water flowing through the spiral guide 133 only at the recessed section 111a, so enabling concentrated heat exchange around the end of the combustion port 113, as shown in FIG. 5

In addition, it is needless to say that the spiral guide 133 at the portion where the recessed section 111a is formed is provided to extend to the recessed section 111a as shown in FIG. 5.

The distribution cooling pipe 140 allows the cooling water supplied through the cooling water supply pipe 150 described below to primarily exchange heat throughout the entire combustion port 113 and then to flow to each cooling room 130 provided in a pair of flanges 111.

For this purpose, the distribution cooling pipe 140 is a cylindrical shape having a predetermined length and being secured at both ends to the inner surface of a pair of flange 111 while surrounding the outer circumferential surface of the combustion port 113 to be spaced apart, thereby forming a flow path through which cooling water flows between the distribution cooling pipe 140 and the outer circumferential surface of the combustion port 113, as shown in FIG. 4 to FIG. 7.

The flow path between the distribution cooling pipe 140 and the outer circumferential surface of the combustion port 113 is divided into a first supply flow path 142 and a second supply flow path 143 by a partition panel 141 disposed in the center of the longitudinal direction of the distribution cooling pipe 140 so that the supplied cooling water may be simultaneously directed to each cooling room 130 provided in a pair of flanges 111. In addition, as shown in FIGS. 5 to 7, an inlet holes 140a communicating with the cooling rooms 130 is respectively formed at both ends of the distribution cooling pipe 140 so that the cooling water supplied to the first supply flow path 142 and the second supply flow path 143 respectively induces into each cooling room 130 provided in both the flanges 111.

The inlet hole 140a is formed to communicate with the beginning of the spiral guide 133 of the cooling room 130 as shown in FIG. 6 and FIG. 7, thereby allowing the flow of the introduced cooling water to occur from the center of the spiral guide 133.

Accordingly, the distribution cooling pipe 140 allows the cooling water supplied to the first supply path 142 and the second supply path 143 respectively to come into contact with the entire surface of the combustion port 113 while flowing to each cooling room 130 through each communication port, thereby enabling continuous heat exchange of the entire combustion port 113 using the initially supplied cooling water.

On the other hand, as shown in FIG. 5, a focusing baffle plate 144 having a plate-like ring shape having an inclination in the range of 25 degrees to 35 degrees is provided on each inner side of the first supply flow path 142 and the second supply flow path 143 of the distribution cooling pipe 140.

The outer circumference of the focusing baffle plate 144 is fixed to the inner circumferential surface of the distribution cooling pipe 140, and the inner diameter of the inner side thereof penetrate the outer circumferential surface of the combustion port 113 and is disposed apart from the outer circumferential surface, thereby forming a gap t through which cooling water passes between the inner diameter and the outer circumferential surface of the combustion port 113.

The gap t above allows the flow velocity of the passing cooling water to be concentrated at the corners of both ends of the combustion port 113 as shown by the arrows in the enlarged view of FIG. 5, thereby inducing concentrated heat exchange at the corners that are continuously subjected to pressure by the reaction between the combustion gas and the feedstock oil, so fundamentally preventing the phenomenon of the internal diameter of the corners, which are relatively vulnerable portion A due to long-term exposure to a high-temperature environment, from melting.

There are problems that if the inclination of the focus baffle plate 144 is formed 25 degrees or less, the inclination becomes too gradual, causing the cooling water to collide with the focusing baffle plate 144 and form vortex, resulting in a stagnant flow phenomenon that slows down passage through the gap t, thereby preventing concentrated heat exchange at the vulnerable portion A, whereas, if the inclination is 35 degrees or more, the cooling water passes through the gap t too quickly due to the steep slope formation, leading to decreased heat exchange efficiency at the vulnerable portion A.

Therefore, it is ideal for the inclination of the focusing baffle plate 144 to be maintained in the range of 25 to 35 degrees, and within this inclination range, heat exchange in the vulnerable portion A can be maximized due to the flow velocity of the cooling water passing through the gap t.

The cooling water supply pipe 150 is formed in a pair, and is directly provided in the first supply flow path 142 and the second supply flow path 143, as shown in FIGS. 4 to 7, to ensure that the cooling water is supplied.

The cooling water drain pipe 160 is formed in a pair, and is provided in each cooling housing 131 of the cooling room 130 provided in each of the flanges 111, as shown in FIG. 4 to FIG. 7, to enable the drainage of cooling water that has exchanged heat while flowing in the combustion port 113 and the cooling room 130.

In this case, the cooling water drained through the cooling water drain pipe 160 flows into a cooling tower (not shown), and the cooling water whose temperature drops while passing through the cooling tower is re-supplied to the first supply flow path 142 and the second supply flow path 143 through the cooling water supply pipe 150, and heat-exchanges the reactor through continuous circulation.

Meanwhile, a plurality of supporter members 115 may be radially disposed between a pair of flanges 111 to maintain the flanges 111 in a spaced state.

That is, the radial supporter member 115 fundamentally prevents the spaced-apart flanges 111 from being inclined in either direction, thereby allowing the coupling state between each structure fixed by welding to be maintained.

In this embodiment, the supporter member 115 is depicted as being disposed between a pair of cooling rooms 130, but its position is not limited thereto.

Hereinafter, the heat exchange process of the carbon black reactor 100 according to the present disclosure will be described as follows with reference to the accompanying figures.

When feedstock oil is supplied to the carbon black reactor 100 through the injection nozzle 120, the inducing combustion gas and the supplied feedstock oil react at high temperature inside the combustion port 113 to generate a mixed gas containing carbon black.

In this case, the cooling water is supplied to the first supply flow path 142 and the second supply flow path 143 of the distribution cooling pipe 140 through the two cooling water supply pipes 150, respectively, for cooling of the carbon black reactor 100.

The cooling water supplied to the first supply path 142 and the second supply path 143 flows inside the first supply path 142 and the second supply path 143 and exchanges heat with the combustion port 113 through contact with the combustion port 113.

As the cooling water passing through the combustion port 113 passes through the gap t of the focusing baffle plate 144, the flow velocity increases and intensively exchanges heat at the vulnerable portion A at the end of the combustion port 113, as shown in the enlarged view of FIG. 5.

The cooling water having passing through the vulnerable portion A flows into the spiral guide 133 of the cooling room 130 through the inlet hole 140a, induces in the spiral direction along the spiral guide 133, and diffuses to the entire flange 111 plate surface.

In this case, the cooling water is brought into contact with the flange 111 in the process of flowing through the spiral guide 133 to exchange heat, and finally supplied to the cooling tower (not shown) through the cooling water drain pipe 160.

The cooling water supplied to the cooling tower is re-supplied to the first supply flow path 142 and the second supply flow path 143 through the cooling water supply pipe 150 in a low-temperature state, and is repeatedly circulated inside the carbon black reactor 100 to exchange heat.

As described above, the carbon black reactor of the present disclosure has an excellent effect of fundamentally preventing the diameter of the combustion port from being deformed by continuous exposure at a high temperature as in the related art by manufacturing the combustion port of carbon black reactor with a heat-resistant metallic material, supplying cooling water in both directions to increase the cooling efficiency of the combustion port heated to a high temperature, and cooling the combustion port while the supplied cooling water flows in a state where it is enveloped by cooling water.

In particular, the structural effect of further enhancing the stability of the vulnerable portion by allowing the flowing cooling water to concentrate to the vulnerable portion around the diameter of the end portion of the combustor is also excellent.

Further, it is possible to keep the quality of a carbon black produced constant as the shape of the combustion port of the carbon black reactor is maintained, and above all has the effect of not generating refractory waste as in the prior art.

The carbon black reactor of the present disclosure has been described above with reference to preferred embodiments and the accompanying figures, but this is merely intended to facilitate in the understanding of the disclosure and is not to limit the technical scope of the disclosure.

That is, it should be understood that various modifications and alterations are possible for those skilled in the art without departing from the technical gist of the present disclosure, and such modifications and alteration are within the technical scope of this disclosure in light of the interpretation of the appended claims.

### DESCRIPTION OF SYMBOLS

100: carbon black reactor 110: body
111: flange 111a: recessed section
111b: coupling hole 113: combustion port
114: notch portion 115: supporter member
120: injection nozzle 121: injection socket
130: cooling room 131: cooling housing
133: spiral guide 140: distribution cooling pipe
140a: inlet hole 141: partition panel
142: first supply flow path 143: second supply flow path
144: focusing baffle plate 150: cooling water supply pipe
160: cooling water drain pipe t: gap

1. A carbon black reactor having a cooling function, comprising:
a body made of a metallic material which has a pair of flanges made of a heat-resistant metallic material spaced apart from each other, and a combustion port made of a heat-resistant metallic material with a central portion penetrated which combustion gas and feedstock oil are reacted while connecting the spaced flanges, wherein the pair of flanges and the combustion port are made of different heat-resistant metallic materials;
a plurality of injection nozzles configured to inject a feedstock oil into the combustion port;
a pair of cooling rooms respectively provided on an inner plate surface of the flange facing each other, and configured to exchange heat of the flanges while diffusing cooling water across the entire surface of the flanges;
a distribution cooling pipe that surrounds an outer circumferential surface of the combustion port to be spaced apart to form a flow path, and is partitioned into a first supply flow path and a second supply flow path through a partition panel so that the supplied cooling water is directed to each cooling room while exchanging heat with the entire combustion port;
a pair of cooling water supply pipes provided in the first supply flow path and the second supply flow path, respectively, and configured to supply cooling water; and
a cooling water drain pipe, which is provided in each of the pair of cooling rooms and drains heat-exchanged cooling water,
wherein the cooling room comprises:
a circular cooling housing disposed on an inner plate surface of the flange while penetrating the distribution cooling pipe, and forming a cooling space so that cooling water can flow from the distribution cooling pipes for heat exchange of the flanges; and
a spiral guide disposed inside the cooling housing and forming a flow path so that cooling water inducing from the distribution cooling pipe is spirally diffused toward the outside of the flange plate surface.

2. The carbon black reactor of claim 1, wherein:
an inlet hole communicating with the cooling room is formed at both ends of the distribution cooling pipe so that cooling water supplied to the first and second supply flow paths, respectively, flows into the cooling room.

3. The carbon black reactor of claim 1, wherein:
a gap t is formed inside each of the first and second supply flow paths of the distribution cooling pipe so as to be spaced apart from an outer circumferential surface of the combustion port in an inclined manner in a range of 25 degrees to 35 degrees in a state of being fixed to the distribution cooling pipe, so that a flow velocity of cooling water passing through the gap t can be concentrated to both end portions of the combustion port.

4. The carbon black reactor of claim 1, wherein:
a recessed section for delaying a flow time of cooling water is formed on a flange plate surface provided with the cooling room so that heat exchange of the cooling water flowing in the cooling room can be concentrated around end portions of the combustion port.

5. The carbon black reactor of claim 1, wherein:
the injection nozzle is coupled to a plurality of injection sockets penetrating the distribution cooling pipe in a state of being radially disposed in the combustion port.

6. The carbon black reactor of claim 1, wherein:
a notch portion made of a heat-resistant metallic material for reinforcing the carbonization of the diameter corner of the combustion port is further provided around the diameter of the end portion on one side of the combustion port.

7. The carbon black reactor of claim 1, wherein:
a plurality of supporter members is disposed radially between the pair of flanges maintain a spaced-apart state of the flanges.

8. The carbon black reactor of claim 1, wherein:
the heat-resistant metallic material of the combustion port comprises SU316L and the heat-resistant metallic material of the pair of flanges comprises iron with added chromium, nickel, and manganese.
